(19) United States
(12) Patent Application Publication
(10) Pub. No.: US 2026/0299562 A1
(43) Pub. Date: Oct. 1, 2026

(54) Method and Arrangement for Controlling an Industrial Automation Arrangement via Dynamically Orchestrated Software Agents

(71) Applicant: Siemens Aktiengesellschaft, Muenchen (DE)

(72) Inventors: Nathalie SCHNELZER, Erlangen (DE); Armin HADZALIC, Erlangen (DE); Matthias HERBORT, Erlangen (DE)

(21) Appl. No.: 19/630,739

(22) Filed: Mar. 27, 2026

(30) Foreign Application Priority Data
Mar. 28, 2025 (EP) 25166935

(51) Int. Cl. G05B 19/418

(52) U.S. Cl. CPC G05B 19/41835

(57) ABSTRACT

A method and to an arrangement for controlling an industrial automation arrangement, wherein during a first step, a request of a user is transmitted to a local client component of an orchestrator, in a second step, the request is supplemented with items of context information and with items of control information and transmitted to a server component of the orchestrator, in a third step, at least one AI agent is selected and retrieved for generating at least some controller commands required for fulfilling the request, where the respectively retrieved AI Agent processes the request and transmits a response with the controller commands back to the server component, in a fourth step, controller commands generated by the AI agent are transmitted to the client component, and in a fifth step, an adapter is supplied with the controller commands, and the automation arrangement is controlled via the adapter and a control facility.

### BACKGROUND OF THE INVENTION

### 1. Field of the Invention

The invention relates to a system and method for controlling an industrial automation arrangement via software agents, based on artificial intelligence.

### 2. Description of the Related Art

Artificial intelligence (AI) agents use “Large Language Models (LLMs)” to provide solutions for various domains. These AI agents cannot only create text-based responses to requests, rather they also enable the execution of defined actions, for example, the call-up of Web Application Programming Interfaces (APIs) or other software components. Broadly speaking, AI agents can prompt local adapters to actions, with the local adapters in turn being able to trigger a real action, in particular for controlling an industrial task, usually via an industrial controller (for example, programmable logic controller (PLC)), which has the adapter or is communicatively connected thereto.

Currently, AI agents can execute actions only locally. The execution of actions is therefore dependent on the execution site of the AI agent. This dependence is problematic for the following reasons:
The execution of AI agents and LLMs that are used places high demands on hardware environments that are required.
AI agents often include protected knowledge (intellectual property). This knowledge should often not be installed on local devices upon which local actions are to be executed (for example, Engineering PCs, industrial controllers or HMI panels).
Distributed execution of actions triggered by AI agents is currently only possible with additional external methods and is not part of the interaction of AI client and AI agent.

Popular agent and LLM frameworks, such as LangChain, LangGraph, AutoGen or “Semantic Kernel”, can only execute actions “locally”. An AI Agent, which is executed, for example, in the Cloud, can execute actions only in the Cloud. This means that AI agents currently have to be executed in the environment in which they are to execute actions, or that AI agents use external functionality in their execution environment to enable execution of actions in remote clients.

### SUMMARY OF THE INVENTION

In view of the foregoing, it is therefore an object of the present invention to provide artificial intelligence, which is implemented in AI agents, utilizable for controlling industrial procedures in a distributed execution environment, in particular in a Cloud environment, where the site of execution of the actions of AI agents for industrial application is decoupled from the site of execution of the agents themselves.

These and other objects and advantages are achieved in accordance with the invention by a method for controlling an industrial automation arrangement, where via at least one software agent based on artificial intelligence (e.g., an AI agent) using a natural-language request input by a user, controller commands are generated for at least one industrial control facility of the automation arrangement and are used by the control facility for controlling the automation arrangement, and where at least one adapter for exchanging the controller commands between the AI agent and the control facility is associated with the control facility. In a first step, via an assistance system based on artificial intelligence (e.g., an AI Copilot), the request of the user is transmitted to a local client component of an orchestrator. In a second step, via the client component, the request is supplemented with items of context information about the automation arrangement and with items of control information about the at least one local adapter of the control facility and transmitted to a server component of the orchestrator. In a third step, via the server component, using the supplemented request, at least one of the AI agents is selected and retrieved for generating at least some of the controller commands required for fulfilling the request, where the respectively retrieved AI agent processes the request and transmits a response with the controller commands back to the server component. In a fourth step, via the server component, the controller commands generated by the AI agent(s) are transmitted to the client component. In a fifth step, via the client component, using the items of context information and the items of control information, the adapter(s) are supplied with the controller commands and, finally, the automation arrangement is controlled via the adapter(s) and the at least one control facility. Such a method makes it possible to employ a number of (possibly in each case specialized) AI agents, which execute in one or more execution environment(s) suitable for them, in order to control an industrial automation arrangement decoupled therefrom.

The objects and advantages are also achieved in accordance with the invention by an arrangement for controlling an industrial automation arrangement, where at least one software agent based on artificial intelligence (e.g., an AI Agent) using a natural-language request input by a user, is configured to generate controller commands for at least one industrial control facility of the automation arrangement, where the control facility is configured to control the automation arrangement, and where at least one adapter for exchanging the controller commands between the AI agent and the control facility is associated with the control facility. The arrangement comprises an assistance system based on artificial intelligence (e.g., an AI Copilot) for transmitting the request of the user to a local client component of an orchestrator, where the client component is provided for supplementing the request with items of context information about the automation arrangement and with items of control information about the at least one local adapter of the control facility and for transmitting the supplemented request to a server component of the orchestrator, where the server component is configured to select and retrieve at least one of the AI agents for generating at least some of the controller commands required for fulfilling the request using the supplemented request, where the AI Agent is established for processing the request and for generating and transmitting a response with the controller commands back to the server component, where the server component is configured to transmit the controller commands generated by the AI agent(s) to the client component, and where the client component is configured to transmit the controller commands to the adapter(s) and to control the automation arrangement via the adapter(s) and the at least one control facility using the items of context information and the items of control information. The advantages previously discussed based on the method can be implemented with this arrangement.

Advantageously, in the third step, the relevant AI agents and the appropriate call-up sequence are ascertained by the server component based on the text of the request, the list of available agents, items of context information, local skills, and/or the automation domain knowledge. The selection and the sequence in which the individual AI agents are used are thereby not solely dependent on the request of the user, but rather they are also influenced by items of information that already exist. This results in the selection and the call-up sequence being more accurate and in the user being able to place requests or assignments more easily, with the controlling purpose still being reliably achieved.

Advantageously, the AI agents are configured as a service, in particular as a RESTful service, where the request and the response in are formulated in a defined request and response format during the third step. It is thereby possible to operate each different AI agent autonomously and use them inflexibly for different architectures without having to adapt each of the interfaces.

Advantageously, the response comprises a response text, a query and/or as controller commands, a job list for actions of at least one of the adapters. Different potential problems are countered thereby because, firstly, a response text results in improved communication with a user, and because, secondly, queries purposefully call up those items of information- and, more precisely, in the case of a user or in the case of other parts of the system, for example, the adapters-which are necessary for fulfilling the task, and because, in relation to third job lists, are particularly suitable for controlling sequential industrial processes and procedures. Consequently, renewed communication between the industrial controller, the associated adapter and the AI-based system is not necessary for every sub-step. Advantageously, in the fifth step, in the event of a query by the server component, this query is solved by a dialog with the user or by an automated request to the adapter or other system components and a response relating thereto is transmitted back to the inquiring AI agent via the server component, after which this AI Agent generates a new response or continues its work which was previously uninterrupted for the query.

It is a particular strength of the orchestrator to dynamically employ, i.e., flexibly at runtime, a large number of AI agents, which can have particular skills in each case, in order to achieve a control task. It is advantageous for this purpose if step responses of different AI agents to the same request are combined by the server component into a response consolidated for the respectively concerned adapter.

Analogously thereto, a large number of controllers are frequently active in an automation arrangement, so a large number of adapters for respective communication with these controllers or control facilities is present. Advantageously, the job lists are therefore distributed by the server component among the respectively relevant adapters. Furthermore, in a particularly advantageous embodiment, the client component is configured to examine the elements of a job list in each case for which control facility, and thereby which adapter, is suitable, responsible, or most suitable for execution, and thus to implement or correct an appropriate distribution of the individual elements of job lists. Instead of direct communication with the controllers or control facilities, depending on manufacturer or configuration, an engineering system can also be interconnected which effects access to the controllers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the inventive method and of the inventive apparatus respectively will be explained below on the basis of the drawings, in which:

FIG. 1 shows a system overview of the inventive arrangement;

FIG. 2 shows a request-response cycle with the execution of local actions;

FIG. 3 shows the inventive method in a workflow for autonomous cycles; and

FIG. 4 shows autonomous cycles and interaction cycles with the structured request-response format.

### DETAILED DESCRIPTION OF THE EXEMPLARY EMBODIMENTS

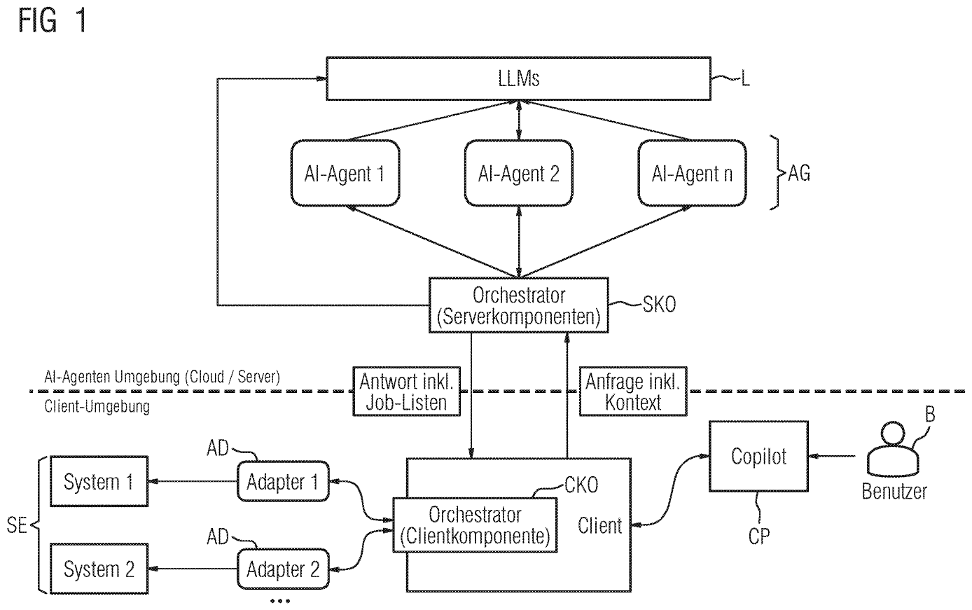

FIG. 1 shows a system overview of the inventive arrangement. The client environment, often also called the local environment, can be found in the lower part of the illustration. This is the execution context with which the user B interacts and from which the industrial control facilities SE, which are hereby designated System 1 and System 2, are actuated. The control facilities SE can be, for example, memory programmable controllers or similar facilities, which directly control an industrial process or an industrial automation for the production of piece goods or the like. The control facilities SE are frequently not identical to the computer platform on which a local component, what is known as the client component CKO, of the orchestrator, described in more detail later, runs. It is essential that the user B communicates exclusively with an (artificial) intelligent component, called AI Copilot CP or Copilot CP for short, which in this regard has a user interface for exchanging natural-language items of information and possibly graphical items of information. While the client environment is local with respect to the controlled industrial process, but in exchange has only limited skills for executing programs for implementing artificial intelligence, what are known as AI agents AG, the upper part of FIG. 1 shows a powerful platform for executing such complex applications, such as a server in a Cloud. The server component SKO of the orchestrator is also arranged in this domain. Client component CKO and server component SKO are communicatively connected, for example, via an Internet-based communication channel (for example, https protocol) or a Virtual Private Network (VPN).

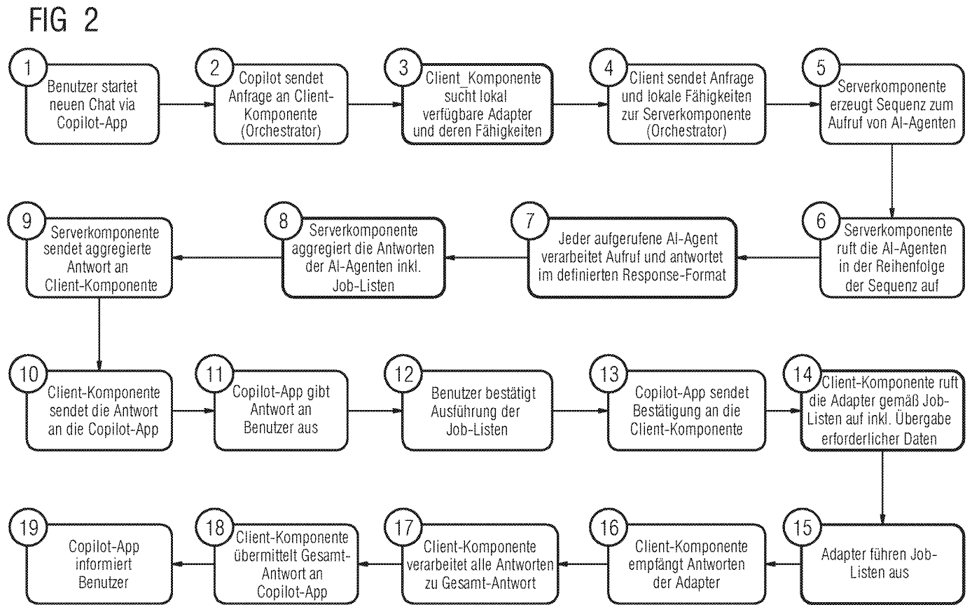

FIG. 2 shows an exemplary flowchart of a request-response cycle with the execution of local actions, i.e., such actions that are performed by the control facilities SE (called System 1, System 2 in FIG. 1) in order to influence the industrial automation arrangement. FIG. 2 denotes the actions 1, . . . , 19 in the form of a workflow, with, in particular, the actions 3, 7, 8, 14 and 15 being different from the actions known from the prior art. It is essential in step 3 in this connection that the client component CKO collates items of information about the adapters AD, with these items of information about the adapters AD providing information about available commands, required parameters and about the skills (also called items of control information in the context of this document) of the connected control facility SE or the machines or devices controlled thereby. In steps 7 and 8, this enables the called-up AI agents and the server component SKO of the orchestrator to purposefully create commands and possibly queries and to activate the responses provided by the different AI agents AG into a collective response that is then finally forwarded to the client component CKO. This is possible due to a defined request-response format, which allows diverse AI agents AG and diverse adapters AD to be able to collaborate for a shared work task.

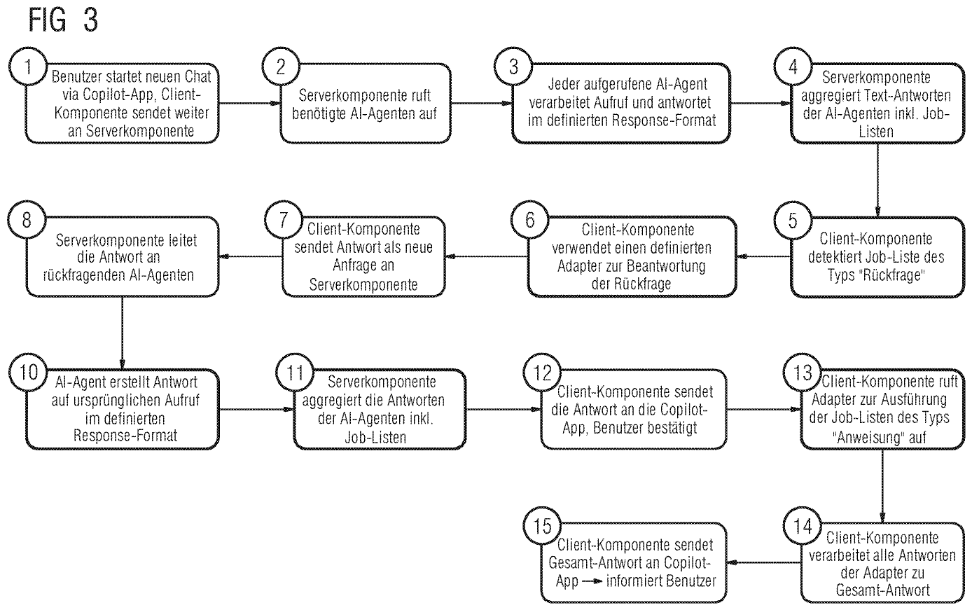

FIG. 3 substantiates the inventive method for autonomous cycles, with steps 1, . . . , 15 being shown, here. In contrast to the prior art, steps 3-5 here describe the case in which the AI agents AG create not only conventional job lists in the form of a respectively directly executable list of commands for the adapters AD, rather require further items of information for creating their response that can ultimately be used. Therefore, in other words, a job list of the “query” type is created, with it firstly being possible that a query to the human user B is required, and secondly, further items of information about the system to be controlled, in particular the adapter AD, are required. FIG. 3 represents the case of the query to one of the adapters AD (see step 6). As mentioned, a request can also be sent to the user B via Copilot CP, however. After all items of information have been provided (see step 10 and 11), the definitive response is formulated, so only job lists of the “command” type (see step 13) with controller commands still remain, and these ultimately are executed (possibly after confirmation by the user B) by the adapters AD and thus by the control facility SE.

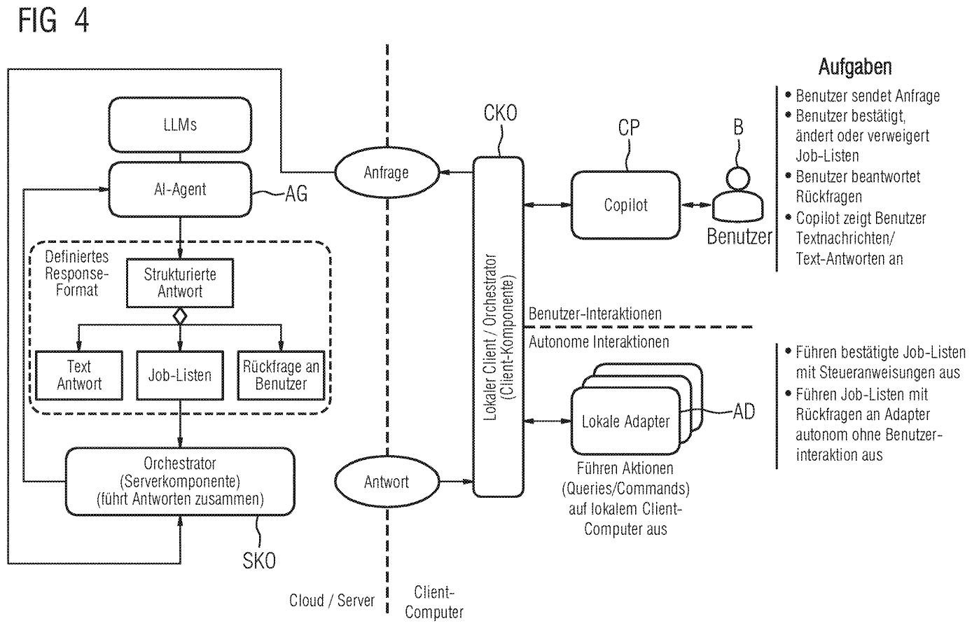

FIG. 4 shows a representation as an alternative to FIG. 1, with the execution environment with the AI agents AG (server, Cloud) being shown on the left-hand side and the client computer with the adapters AD and the local Copilot CP being shown on the right-hand side, here. On the far right, the tasks of the group comprising user B and Copilot CP are shown in the upper part and the tasks of the part with the local adapters AD are shown in the lower part. The client component CKO of the orchestrator firstly represents the link between Copilot CP and the local adapters AD, and secondly, the link between the client computer and the higher-order execution environment (server/Cloud) and the server component SKO arranged therein.

In the prior art, AI agents AG can control only local adapters AD, with a 1-to-1 allocation between an AI agent AG and an adapter AD also always being stipulated in the prior art. This architecture requires considerable “on-premise” computing power, i.e., in the local industrial environment, for execution by AI agents, which can in each case separately control only a self-contained part of an automation arrangement. Inventively, these restrictions are overcome firstly by a decoupling between the AI agents AG and the adapters AD, which ultimately actuate the control facilities SE.

This decoupling is made possible by the “job lists” mechanism described below, and an “orchestration”:
Industrial “Copilots” CP transfer
   a text-based request,
   items of context information, and
   a list of the actions available on the client (what are known as items of control information) and their required items of input information.
The central orchestrator CKO, SKO ascertains the relevant AI agents AG and an appropriate call-up sequence based on the text of the request, the list of available agents AG, items of context information, local skills, and/or the automation domain knowledge.
The orchestrator CKO, SKO calls up the AI agents AG in accordance with the ascertained call-up sequence. The AI agents AG are actioned as a RESTful service and implement standardized interfaces (a defined “request” and “response” format). The problems described in the introduction are addressed in this connection by the use of a structured “response format”.
The called-up AI agents AG process the request and create an appropriate response. This response follows the defined “response” format and can include the following elements:
   response text (“text response”)
   query: a query to a user (“Query to the User”)
   a dynamically created list of “job lists”.

Each job list is an ordered list of actions including required data/parameters, which a defined local adapter is to execute. Job lists are either the Query or Command type. “Queries” automatically request additionally required items of information (“items of control information”), while “Commands” execute specific changes (creating, modifying or deleting data), possibly after confirmation by the user B, thus represent controller commands.
The orchestrator CKO, SKO dynamically composes a response from the various responses of the participating AI agents AG and returns it to the calling client or the local client component CKO.
The client displays responses or queries and uses the locally available adapter to locally execute the returned job lists (what are known as controller commands).
The local adapters AD also return responses, these may also be acknowledgements or items of status information about the industrial process, to the local client. This in turn uses the orchestrator CKO to create a consolidated response from the various responses, and this is finally displayed to the user.

The “System Overview” illustration (FIG. 1) shows the typical structure of a distributed AI system.

FIG. 2 illustrates a typical flow (request/response cycle) in this system.

Additionally, the described method also allows interactions, which consist of multiple cycles. These enable queries to the user B and/or queries, which are answered completely automatically, to local adapters AD—see FIG. 3.

The fundamental difference from other conventional solutions consists in that
1. The execution site of the actions triggered by AI agents AG is independent of the execution site of the AI agents AG.
2. The execution of the triggered actions is an integral component of the workflow between AI client (in particular the adapters AD) and AI agents AG.
3. The “response format” corresponds to a defined structure (“Job Lists”, “Text Response”, “Query to the User”). This format (see also FIG. 4) enables:
   a. The execution of local actions using the locally available functionality (provided by adapters AD)
   b. Autonomous queries to the local adapters AD.
4. The orchestrator CKO, SKO combines the structured responses of different AI agents and controls a structured cyclical communication between AI agents AG and the local level (client level) as a result.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling an industrial automation arrangement, via at least one software agent based on artificial intelligence, utilizing a natural-language request input by a user, controller commands are generated for at least one industrial control facility of the automation arrangement and are utilized by the control facility for controlling the automation arrangement, and at least one adapter for exchanging the controller commands between the AI agent and the control facility being associated with the control facility (SE), the method comprising:
transmitting, in a first step, via an assistance system based on the artificial intelligence, the request of the user to a local client component of an orchestrator;
supplementing, in a second step, via the local client component, the request with items of context information about the automation arrangement and with items of control information about the at least one local adapter of the control facility and transmitting the supplemented request to a server component of the orchestrator;
selecting and retrieving, in a third step, via the server component, utilizing the supplemented request, at least one of the AI agents for generating at least some of the controller commands required for fulfilling the request, a respectively retrieved AI agent processing the request and transmitting a response with the controller commands back to the server component;
transmitting, in a fourth step, via the server component, the controller commands generated by the at least one AI agent to the client component; and
supplying, in a fifth step, via the client component, utilizing items of context information and items of control information, at least one adapter with the controller commands and controlling the automation arrangement via the at least one adapter and the at least one control facility.

2. The method as claimed in claim 1, wherein during the third step, relevant AI agents and an appropriate call-up sequence are ascertained, via the server component, based on at least one of the text of the request, the list of available agents, items of context information, local skills and the automation domain knowledge.

3. The method as claimed in claim 1, wherein the AI agents are configured as a service and, during the third step, the request and the response are formulated in a defined request and response format.

4. The method as claimed in claim 1, wherein during the third step, the response comprises at least one of (i) a response text, (ii) a query and (iii) as the controller commands, a job list for actions at least one of the adapters.

5. The method as claimed in claim 4, wherein during the fifth step, in an event of a query by the server component, this query is solved via one of (i) a dialog with the user (B), (ii) an automated request at an adapter and (iii) other system components, and a response relating thereto is transmitted back to the inquiring AI agent via the server component, after which this AI Agent generates a definitive response.

6. The method as claimed in claim 1, wherein during the fourth step, responses of different AI agents to the same request are combined by the server component into a response consolidated for the adapter concerned.

7. The method as claimed in claim 4, wherein during the fifth step, the job lists are distributed to the respectively relevant adapters via the server component.

8. The method as claimed in claim 5, wherein during the fifth step, the job lists are distributed to the respectively relevant adapters via the server component.

9. The method as claimed in claim 6, wherein during the fifth step, the job lists are distributed to the respectively relevant adapters via the server component.

10. The method as claimed in claim 1, wherein the at least one software agent comprises an AI agent; and wherein the assistance system comprises an AI Copilot.

11. An arrangement for controlling an industrial automation arrangement, at least one software Agent based on artificial intelligence, utilizing a natural-language request input by a user, being configured to generate controller commands for at least one industrial control facility of the automation arrangement, the control facility being configured to control the automation arrangement, and at least one adapter for exchanging the controller commands between the at least one software agent and the control facility being associated with the control facility, the arrangement comprising:
an assistance system based on artificial intelligence for transmitting the request of the user to a local client component of an orchestrator;
wherein the client component supplements the request with items of context information about the automation arrangement and with items of control information about the at least one local adapter of the control facility and transmits the supplemented request to a server component of the orchestrator,
wherein the server component is configured to, utilizing the supplemented request, select and retrieve at least agent of the at least one software Agent for generating at least some of the controller commands required for fulfilling the request;
wherein the at least one software Agent is configured to process the request and generate and transmit a response with the controller commands back to the server component;
wherein the server component is further configured to transmit the controller commands generated by the at least one software Agent to the client component ; and
wherein the client component is configured to, utilizing the items of context information and the items of control information, transmit the controller commands to the at least one local adapter and to control the automation arrangement via the at least one local adapter and the at least one control facility.

12. The arrangement as claimed in claim 11, wherein the at least one software agent comprises an AI agent; and wherein the assistance system comprises an AI Copilot.
